(19) United States
(12) Patent Application Publication
(10) Pub. No.: US 2002/0082787 A1
(43) Pub. Date: Jun. 27, 2002

(54) Method and apparatus for monitoring a product during shipping, storage and use

(76) Inventors: Robert E. Woodworth, Sunnyvale, CA (US); Toan Nguyen, San Jose, CA (US); Paul H. Dick, San Jose, CA (US); Jay Jung, Sunnyvale, CA (US); Marc van den Berg, Saratoga, CA (US)

Correspondence Address: Flehr Hohbach Test, Albritton & Herbert LLP, Suite 3400, Four Embarcadero Center, San Francisco, CA, 94111-4187, US

(21) Appl. No.: 09/895,440

(22) Filed: Jun. 29, 2001

Related U.S. Application Data
(60) Provisional application No. 60/216,775, filed on Jul. 7, 2000.

(51) Int. Cl. G06F 19/00

(52) U.S. Cl. 702/81

(57) ABSTRACT

The present invention provides for an apparatus and method for verifying a product and monitoring conditions of the product during shipping, storage and use. The apparatus includes at least one controller configured to provide functional control to the apparatus. A memory is coupled with controller, and configured to store at least the product identification. The apparatus includes a communication interface coupled with the controller, and is configured to communicate at least the product identification stored in the memory. The controller couples with at least one sensor positioned proximate the product. The sensor is configured to measure at least one condition of the product. The apparatus monitors conditions of the product by initiating at least one measurement of the product conditions, and storing at least one of the measurements. The apparatus further communicates the measurements of the product conditions to allow the determination of the quality of the product.

### REFERENCE TO RELATED APPLICATIONS

The present application claims priority to and incorporates the following application by reference: METHOD AND APPARATUS FOR MONITORING A PRODUCT DURING SHIPPING, STORAGE AND USE, Prov. No. 60/216,775, filed on Jul. 7, 2000.

### FIELD OF THE INVENTION

The present invention relates to an apparatus and method of verifying the identity and quality of containerized products. In particular, the invention pertains to identifying a product and monitoring measurable parameters of the product to allow verification of quality.

### BACKGROUND OF THE INVENTION

After a product is manufactured it is customarily shipped and stored. A product may be re-shipped and restored several times as well as being stored for long periods of time before being used. During shipping, re-shipping and storage the product may be exposed to adverse conditions including adverse temperature, pressure, vibration, and other adverse conditions. These adverse conditions can damage or destroy some products.

In the shipment and storage of chemicals for example, temperature, pressure, agitation and other conditions which a chemical might be exposed to can alter the chemical composition or completely breakdown a chemical making the chemical unsuited for its intended use. In some manufacturing processes, highly sensitive chemicals are used, for example, in semiconductor fabrication. Thus, high quality chemicals are needed to ensure a high quality semiconductor product. If a chemical is damaged or altered during shipping and/or storage, the chemical can have damaging effects during fabrication which are extremely costly and in most cases, uncorrectable.

However, there is not a reliable and cost effective device or process for determining the conditions to which a product or chemical has been exposed during shipping and storing, or the duration of time a product or chemical was stored in a container or storage unit. Further, there is not a reliable and cost effective device or process for determining whether a product or chemical has been exposed to conditions which has exceeded limitations, or has exceeded a shelf life which will cause damaging effects to the product or chemical.

### SUMMARY

The present invention provides for an apparatus and method for verifying a product and monitoring conditions of the product during shipping, storage and use. The apparatus includes at least one controller configured to provide functional control to the apparatus. A memory is coupled with a controller, and configured to store at least the product identification. The controller couples with at least one sensor positioned proximate the product. The sensor is configured to measure at least one condition of the product. The memory is further configured to store at least one measurement from the at least one sensor. In one embodiment the apparatus further includes a communication interface coupled with the controller, and the communication interface is configured to communicate product identification and measurements. The apparatus monitors the conditions of the product by initiating at least one measurement of the product conditions, and storing at least one of the measurements of the product conditions. The apparatus further communicates the measurements of the product conditions to allow the determination of the quality of the product based on the product conditions. In one embodiment, the apparatus communicates product and/or measured data to an external controller. The external controller is configured to verify the product and determine the quality of the product.

### BRIEF DESCRIPTION OF THE DRAWINGS

FIG. 1 is shown a block diagram of one embodiment of one implementation of the data acquisition system or data logger of the present invention;

FIG. 2 depicts a block diagram of one implementation of one embodiment of the data logger memory;

FIG. 3 depicts one example of the monitored data stored within the data logger memory;

FIGS. 4A-D depict block diagrams of embodiments of the data logger in cooperation with the storage unit;

FIG. 5 shows one embodiment of the data logger in communication with an external control system having at least one external controller;

FIG. 6 depicts one embodiment of one implementation of the data logger;

FIG. 7 depicts one embodiment of the storage unit mating with the data logger channel;

FIGS. 8A and 8B show alternative embodiments of the data logger coupled with the storage unit;

FIG. 9 shows the storage unit loaded into an end-use equipment;

FIG. 10 depicts a storage unit with a plurality of sub-storage units;

FIG. 11 depicts a flow diagram of one embodiment of the use of the data logger and associated storage unit;

FIG. 12 shows a flow diagram of initializing and activating the data logger; and

FIG. 13 shows a flow diagram of the end-use equipment interacting with the data logger and the storage unit to withdraw the product from the storage unit.

### DETAILED DESCRIPTION

An apparatus and method for identifying a product and monitoring conditions of the product, such as a chemical, is provided by the present invention. In particular, as illustrated in the figures, the data logger apparatus is a product identification and quality monitoring system used to verify the identity and quality of the product being monitored. Data about the product's current properties and history are retrievable from the data logger for instant analysis. In one embodiment, microprocessor-based data acquisition technology is used along with sensor technology to monitor time and measurable parameters of the product being monitored. Measurable parameters include, but are not limited to, temperature, pressure, density, humidity, vibration, index of refraction and substantially any other measurable parameter. The data logger 120 includes hardware which is attached with, or integrated into a product container, packaging or storage unit 122. The data logger 120 is implemented by any user, such as, but not limited to, a product manufacturer, distributor and end-user. The data logger is activated at any stage between packaging of the product to final use. In one embodiment, the data logger is activated at the point of product manufacture or packaging; alternatively, activation is at the point of shipment. In one embodiment, the data logger is also implemented and activated by an end-user to track inventory and quality during storage, prior to use of the product or chemical. The data logger is capable of monitoring substantially any product which is stored or shipped, whether liquid, solid or gaseous, such as chemicals, corrosive materials, perishable goods, food, medicines, and substantially any other product that is shipped or stored. The data logger is capable of automatically relaying the information acquired about the product to the manufacturer, distributor and/or user without manufacturer, distributor and/or user interaction.

In one embodiment the product identity and manufacturing data are loaded into the data logger memory by the manufacturer, distributor or end-user. Parameters of interest are inputted or stored in memory, along with a time and date stamp. This product information and manufacturing data is retrievable at any time after being loaded into the data logger memory. The data logger continues to monitor product parameters as directed by initiation and procedures, and further records monitored parameters or conditions for later verification of product identity and quality. Monitored data is retrievable from the data logger an unlimited number of times to ensure product quality throughout shipment and storage of the product. In one embodiment, the quality data monitored and stored within the data logger memory is automatically accessed by an external control system or controller. In one embodiment, the external control system is a machinery computer which performs verification of the product and quality prior to use of the product as a security measure. The external control system includes control software directing the external control system to lockout the use of the packaged product if the identity or quality data does not meet user defined specifications. In one embodiment, the data logger provides connection capabilities with other data acquisition and storage devices and/or programs to automate product quality analysis and use.

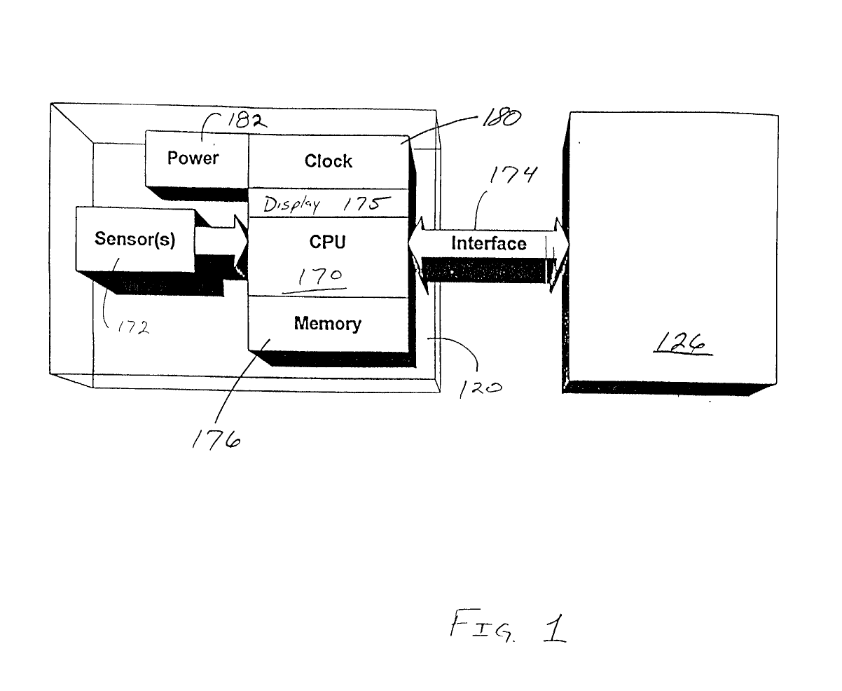

FIG. 1 shows a simplified block diagram of one implementation of one embodiment of the data acquisition system or the data logger 120. In one embodiment, data acquisition of product characteristics and/or conditions is achieved through sensors monitoring time and measurable parameters of the product 124. In the embodiment shown in FIG. 1, the data logger 120 includes at least one processor or controller 170 which provides overall control to the data logger 120. The controller 170 is implemented by substantially any convenient manner which provides overall control including a central processor unit (CPU), a microprocessor, multi-processor and other controllers known in the art. In one embodiment, controller 170 is implemented by an external central processor 126 through communication with the controller 170 within the data logger 120, where communication between the external central processor 126 and the controller 170 is through wired or wireless communication.

The data logger 120 further includes one or more sensors 172. For simplicity, the embodiment shown in FIG. 1 shows one sensor 172; however, the present invention can be implemented with a plurality of sensors without departing from the novelty of the present invention. Sensor 172 provides data input to the controller 170 regarding product characteristics and/or conditions. For example, in one embodiment, sensor 172 provides temperature data experienced by the product 124 being monitored. Sensor 172 is configured to provide substantially any measurable parameter of the product including pressure, temperature, density, humidity, vibration, index of refraction, pH level, level sensor, buoyancy, movement, usage and any other measurable parameter known in the art. When sensor 172 is a temperature sensor, it is implemented through any convenient manner including a thermistor and substantially any other manner known in the art.

In one embodiment, the data logger 120 further includes a communication interface 174. The communication interface 174 provides data communication between controller 170 and external processor 126 or a means for displaying the data 175 to allow data transfer which may be used for further analysis by external processor 126 or an individual viewing the displayed data. In one embodiment the external controller or processor may be a handheld device such as a personal digital assistant (PDA) device or other handheld device configured to receive data from the data logger. Interface 174 is configured in any convenient manner to allow data communication including hardwire or cable socket, radio-frequency (RF) communication interface, optical or light transmission such as infrared (IR) data communication, cellular communication, Bluetooth communication, and substantially any other wired or wireless communication known in the art.

In one embodiment the data logger 120 further includes a clock 180. Clock 180 provides time stamping and is utilized by controller 170 to signal initiation and termination of predefined operations, for example monitoring the temperature of the product 124 once every predefined period of time.

In one embodiment the data logger 120 includes a power source 182. Power source 182 provides power to the data logger 120 and each component of the data logger 120 which require power to operate. Power source 182 is configured as any convenient power source or supply including a power cell or battery such as a lithium or cadmium cell, a solar power source, a power socket for receiving external power, and substantially any other power supply known in the art. In one embodiment, power source 140 is rechargeable to provide continuous reuse for prolonged periods of time. The power source 140 is designed to provide power to the data logger 120 for at least a predefined period. The predefined period may vary based on the product being monitored by the data logger 120, and the number and frequency of monitoring parameters. In one embodiment, power source 182 is configured to provide over a year of power to the data logger 120. In an alternative embodiment, power source 182 is designed to provide at least 10 years of power to the data logger 120.

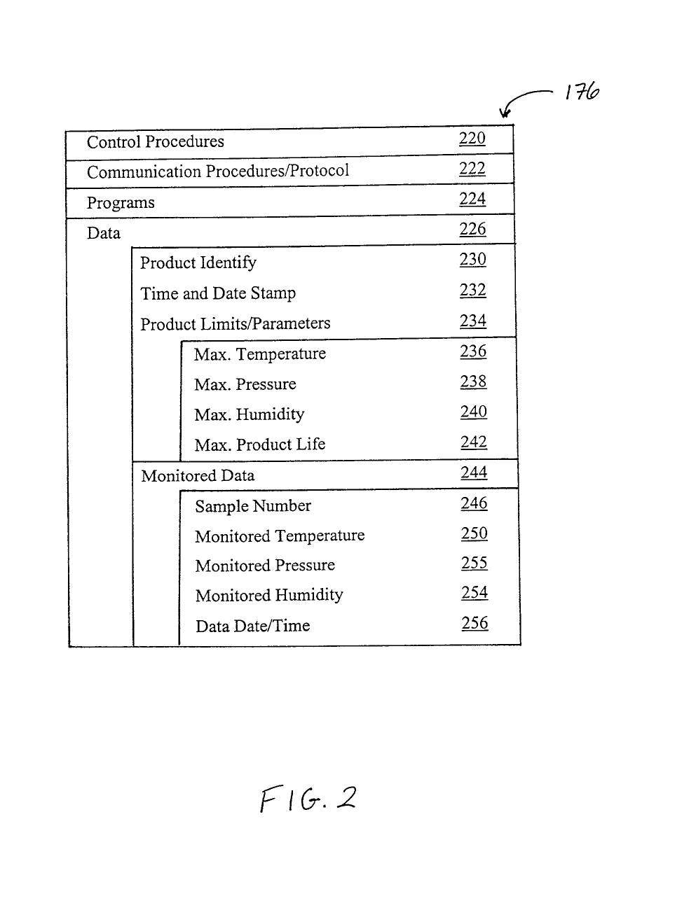

FIG. 2 depicts a block diagram of one embodiment of the data logger memory 176. In one implementation, memory 176 provides storage for operating programs 224, communication procedures and protocols 222, product information, manufacturing data, measured data 244 from sensors 172 and other such information. Memory 176 is configured as any convenient memory type or combination of memory types for storing or maintaining data, including fast semiconductor memory (e.g., RAM or ROM), slower magnetic memory (e.g., hard disk storage), optical memory and any other storage type as is known in the art. Memory 176 includes control procedure 220 and communication procedures 222 for providing the data logger operation and communication control. In one embodiment memory 176 also includes additional programs 224 for operation of additional functions. Data 226 is also stored in memory 176 to be accessed by control and communication procedures 220 and 222. In one embodiment, data 226 includes product identity 230, time and data stamp 232, product limits and/or parameters 234. Product limits and parameters 234 provide quality control limits and parameters, for example, maximum product temperature 236, maximum product pressure 238, maximum product humidity 240, maximum product storage life 242, and substantially any other limit or parameter utilized by the data logger 120 for monitoring the quality of the product. In one embodiment, monitored data 244 includes a sample number 246, monitored temperature 250, monitored pressure 252, monitored humidity 254 and sample date/time 256.

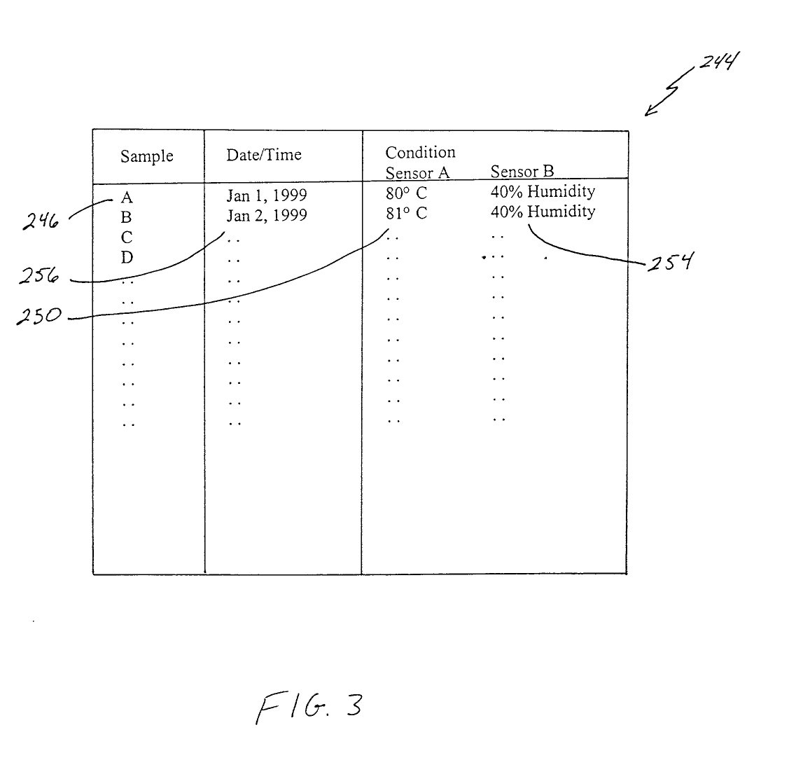

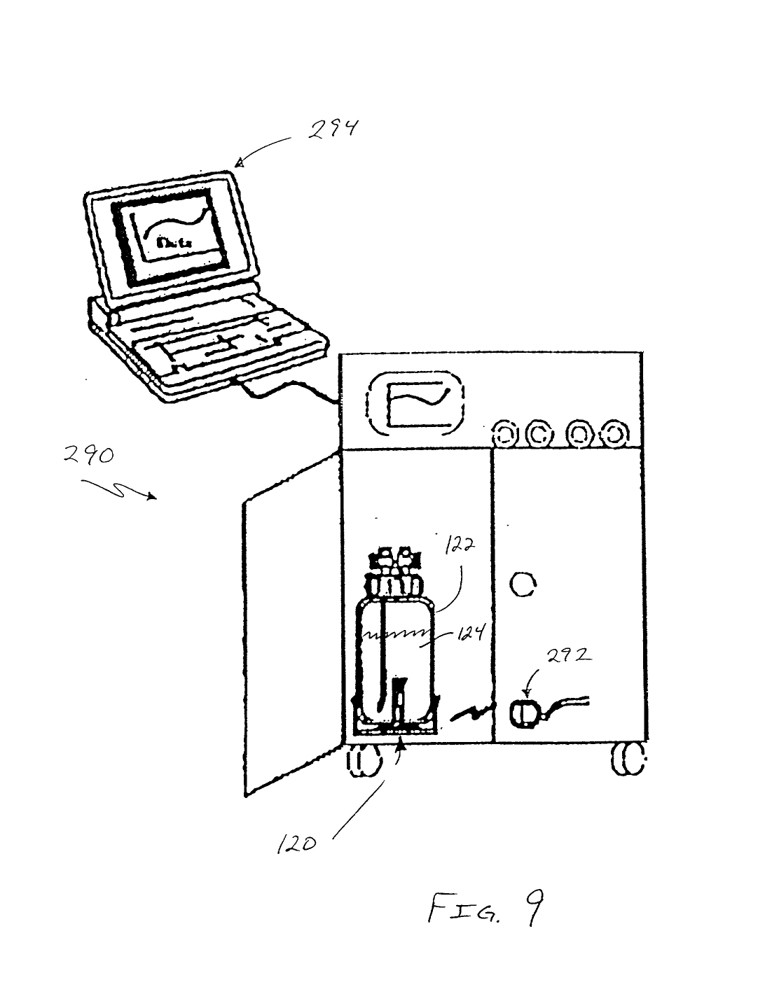

FIG. 3 depicts one example of monitored data 244 stored within memory 176 and potentially reported or displayed through the interface 174 to the external controller 126, end-user machine 290 (see FIG. 9), LED, LCD, monitor or substantially any other manner of displaying monitored data 244. In the example provided in FIG. 3, monitored data 244 includes the sample number 246, sample date/time 256, monitored temperature 250, and monitored humidity 254.

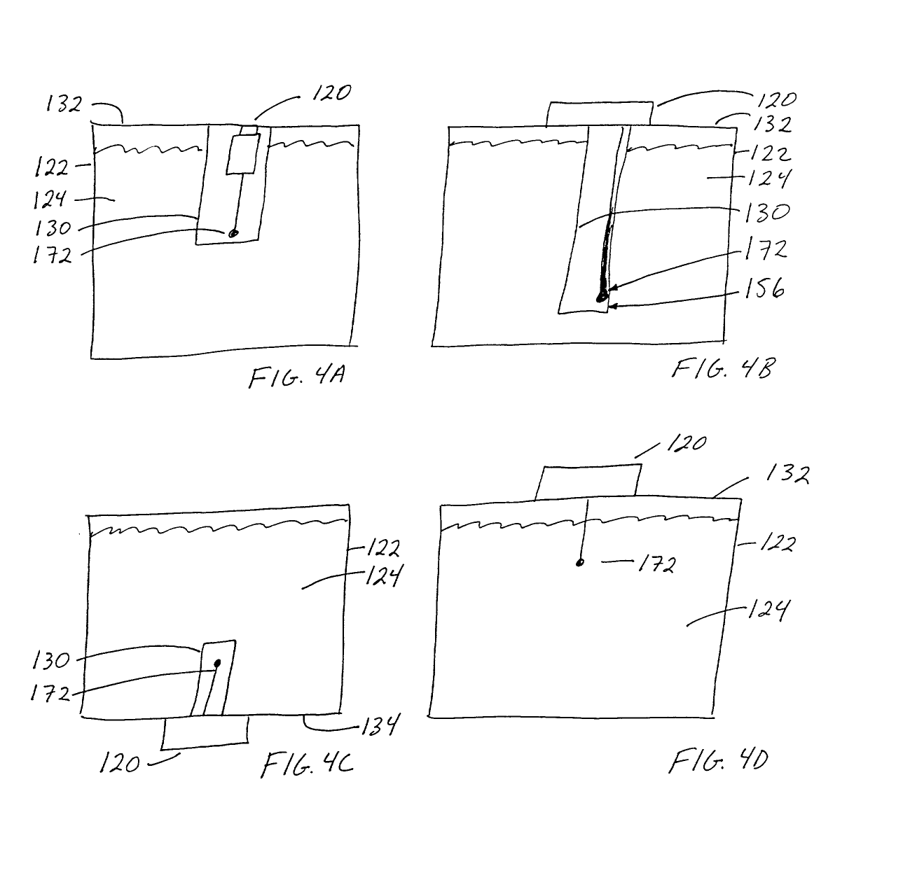

FIGS. 4A-D depict block diagrams of four different implementations for securing the data logger 120 to the storage unit 122. The data logger 120 is secured to the storage unit 122 in substantially any convenient position that allows at least one sensor 172 to be positioned within close proximity of the product 124. The storage unit 122 is configured in substantially any convenient shape to provide stable and secure storage of a the product 124, and which may be transported or shipped to an end-user. FIG. 4A depicts a block diagram of one implementation of one embodiment of the data logger 120. In FIG. 4A the data logger 120 is fixed or secured to the storage unit or container 122 with the data logger 120 inserted within a channel 130 extending from top 132 of the storage unit 122, with sensor 172 extending down into channel 130. FIG. 4B shows an alternate implementation of one embodiment where the data logger 120 is secured externally to top surface 132 of the storage unit 122 while sensor 172 extends into channel 130 and is fixed or secured to side wall 156 of channel 130. FIG. 4C shows the data logger 120 secured to the base 134 of the storage unit 122 while sensor 172 extends up into channel 130. FIG. 4D shows one embodiment where the data logger 120 is secured to top surface 132 of the storage unit 122 while sensor 172 extends into the storage container 122. In one embodiment, the sensor 172 extends through a side wall 156 of channel 130 or the storage unit 122 to be in direct contact with the product 124. It will be clear to one skilled in the art that a plurality of alternative arrangement can be employed for the positioning of the data logger 120 upon or within the storage unit 122 without departing from the inventive aspects of the present invention.

FIGS. 4A-C depict channel 130 which is configured in substantially any convenient manner such as being formed from and a continuous part of the storage unit 122, a separate and detachable subassembly of the storage unit 122, a component of the data logger 120, or any other convenient manner providing positioning of the data logger 120 and sensors 172 on, in, or in proximity to the storage unit 122.

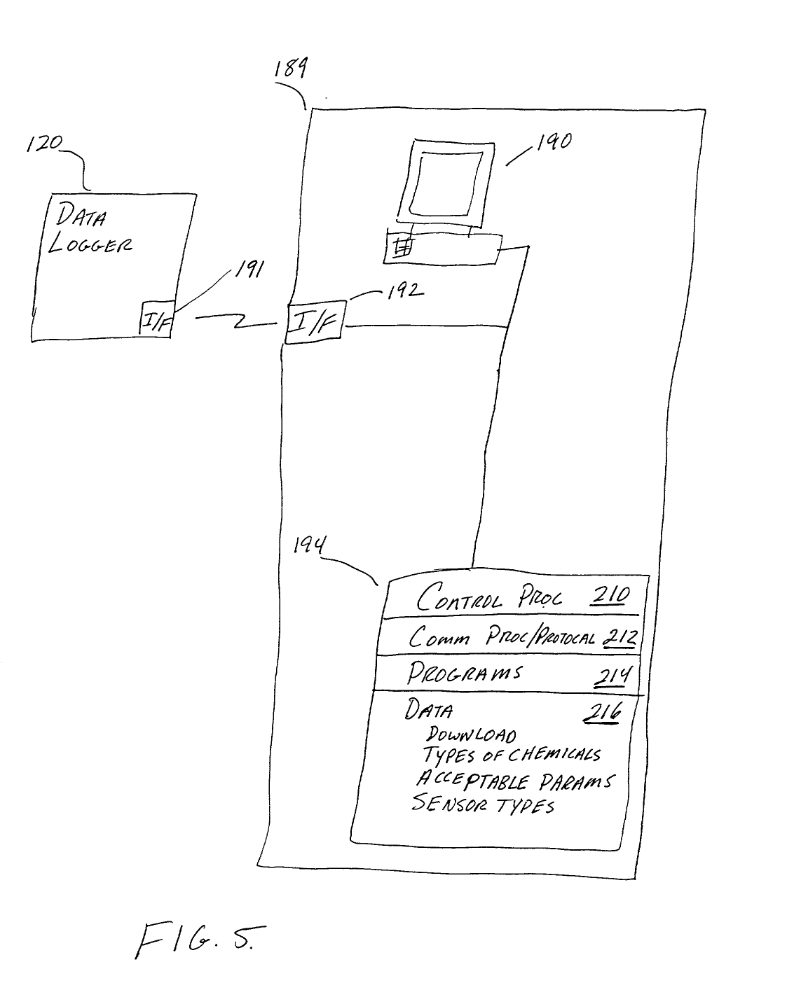

FIG. 5 shows one embodiment of the data logger 120 in communication with external control system 189 having at least one external processor or controller 190. In the embodiment shown in FIG. 5, the data logger 120 wirelessly communicates with the external control system 189 through Interface 191. The data logger 120 is configured to communication with one or more external processors 190 through any convenient communication technique as described above. External communication interface 192 at least receives data signals from communication interface 191 of the data logger 120. In one embodiment interface 191 and external interface 192 are capable of transmitting and receiving data signals. In one embodiment external interface 192 couples with external processors 190. External interface 192 is implemented through substantially any convenient manner to provide data communication including a hardwire or cable socket, radio-frequency (RF) communication, optical or light transmission such as infrared (IR) data communication, cellular communication, Bluetooth communication, and substantially any other wired or wireless communication known in the art.

External processor 190 is configured as any convenient processor, including a central processing unit (CPU), a microprocessor, multiprocessor, computer or substantially any other processor know in the art. External processor 190 couples with external memory 194 which provides data and program storage accessible by external processor 190. External processor 190 is configured to transmit data to and/or receive data from the data logger 120.

In one embodiment, during initialization of the data logger 120, external processor 190 is configured to transmit information or data to the data logger 120 to initiate sensor operation, provide data regarding product 124 stored in the storage unit 122, provide date of initiation, activate clock 180 and any other data, specifications, procedures or programs to be stored by the data logger 120. In one embodiment, external processor 190 through communication with the data logger 120 is further configured to cause the data logger to perform one or more function, for example, take an immediate temperature, clear all memory for resetting the data logger 120 and such similar functions. Additionally, external processor 190 is configured to receive data from the data logger 120. In one embodiment, external processor 190 will receive and perform further analysis on data provided by the data logger 120. For example, external processor 190, will determine if the product 124 meets quality standards. In one embodiment, external processor 190 will provide safety precautions and verification. For example, if the product 124 fails to meet quality standards due to the fact that the product 124 exceeded predefined limits of quality standards, external processor 190 will not use or prevent use of the product 124. In one embodiment, external processor 190 will verify that the product 124 contained in the storage unit 122 is the expected product. If the product is not the expected product, the external processor will indicate the failure and signal that the product should not be used. Alternatively the external processor can be coupled with a manufacturing process 290 (see FIG. 9) which would prevent the use of a product that fails to meet some minimum standard.

Still referring to FIG. 5, external memory 194 provides storage of control procedures 210, communication procedure/protocol 212, programs 214, and data 216 which includes information such as product limitations, parameters and information used to determine when sensors are activated, deactivated, and when sensor information should be stored. External memory 194 is configured as any convenient memory type or combination of memory types for storing or maintaining bit data, including fast semiconductor memory (e.g., RAM or ROM), slower magnetic memory (e.g., hard disk storage), optical memory and any other storage type as is known in the art. Control procedures 210 provide at least some control over the data logger 120. For example, control procedure 210 signal to activate one or more sensors, deactivate one or more sensors, transmit results to the external control system 189, store monitored results from sensors.

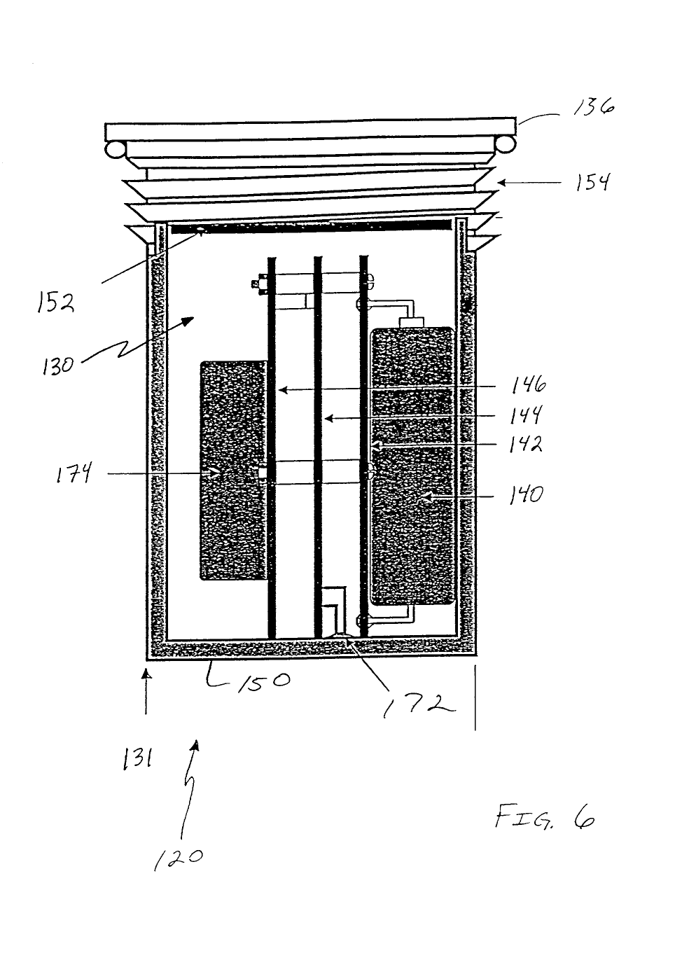

FIG. 6 depicts one embodiment of one implementation of the data logger 120. The data logger 120 includes a housing 131 which defines a channel 130. The housing 131 is sealed with cap 136. A power source 140, a battery board 142, a logger board 144, and an interface board 146 are positioned within the housing 131. The power source 140 couples with the battery board 142 which provides power distribution between the other components of the data logger 120 that require power. The logger board 144 which includes controller 170, memory 176, clock 180 and other elements to provide the desired functions of the data logger 120, couples with the battery board 142 and interface board 146. The interface board 146 includes communication interface 191. In one embodiment, communication interface 191 is configured to provide wireless RF communication. The data logger 120 further includes antenna 152 coupled with interface board 146 to provide transmission of RF signals for wireless communication. Further coupled with logger board 144 is shown one sensor 172. It will be apparent to one skilled in the art that logger board 144 could include a plurality of sensors 172 without departing from the inventive aspects of the present invention. Sensor 172 is positioned in contact with housing 131 to maintain sensor 172 at close proximity to the product 124 contained in the storage unit 122. In one embodiment, sensor 172 is a thermistor secured to a housing base 150 to provide accurate temperature readings of the product 124 in contact with the housing base 150.

In FIG. 6, logger board 144, battery board 142 and interface board 146 are positioned within channel 130 to protect the boards from the product 124 stored within the storage unit 122. The housing 131 is further configured to maintain board positioning during shipment of the storage unit 122 and the produce 124. Positioning of the boards 142, 144, 146 is achieved through any convenient manner such as tongue-and-groove, adhesive, bolts, resin or substantially any other manner known in the art.

In one embodiment, the data logger 120 and/or sensors 172 are packaged within channel 130 or other housing for optimal resistance to chemical attack, shock, extreme temperature and other environmental hazards. The housing 131 is constructed to be resistant to the product 124 stored within the storage unit 122 to maintain structural integrity and protect the data logger components housed within the housing 131. Thus, the housing 131 can be constructed of substantially any material which provides protection from the product 124 including steel alloy, aluminum alloy, plastic, resin or substantially any other material known in the art to provide resistance to the product 124.

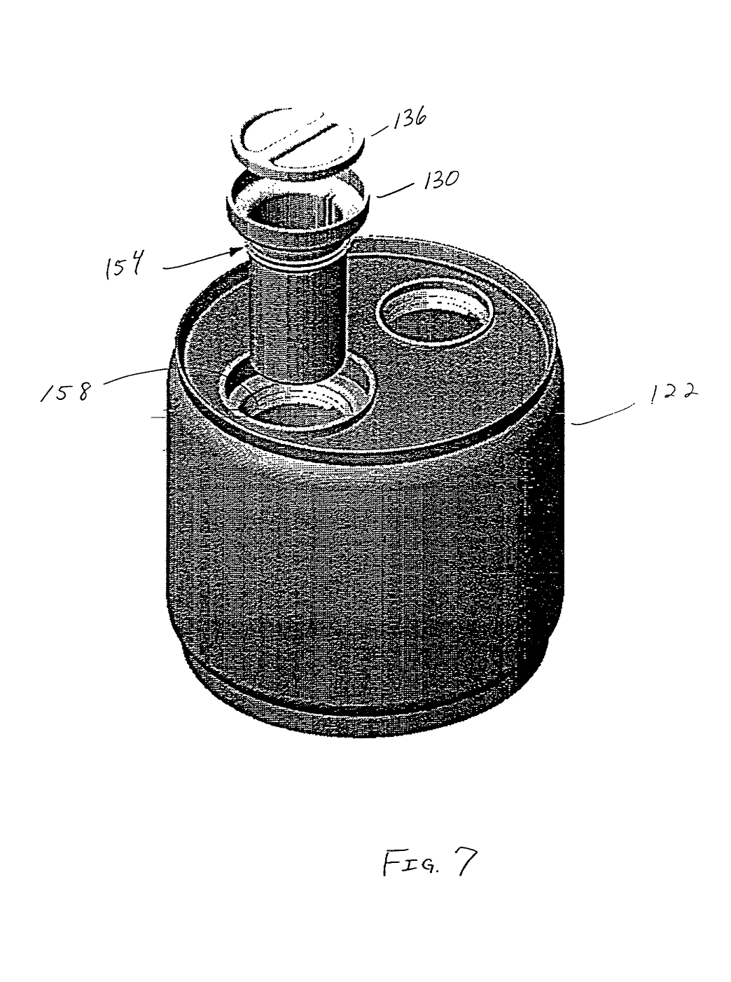

The data logger 120 is secured to the storage unit 122 through any convenient manner including threaded-screw, snap-in, adhesive, press-fit and substantially any other manner for securing the data logger 120 to the storage unit 122. In one embodiment, the housing 131 of the data logger 120 includes threads 154 which correspond to threads 158 (see FIG. 7) on the storage unit 122 to secure the data logger 120 into position within the storage unit 122.

FIG. 7 depicts one embodiment of the storage unit 122 and mating the data logger housing 131 with cap 136. The housing 131 includes threads 154 which mate with threads 158 of the storage unit 122. The embodiment of FIG. 7 provides one example of one implementation of the novel the data logger 120 incorporated within the storage unit 122.

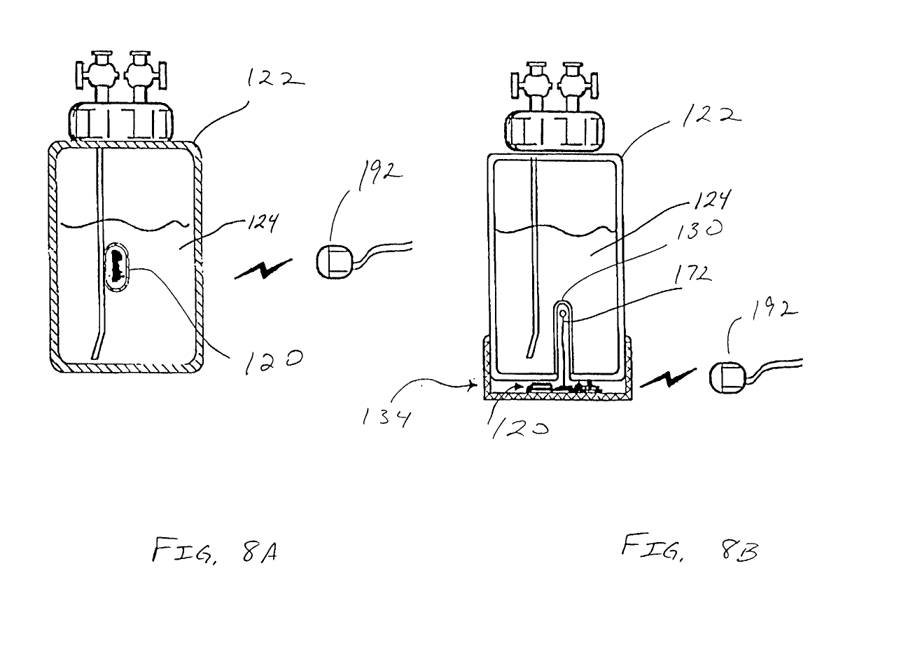

FIGS. 8A and 8B show alternative embodiments of the data logger 120 coupled with the storage unit 122. Referring to the embodiment depicted in FIG. 8A, the data logger 120 is secured internal to the storage unit 122 by a means such as attachment to the draw tube, hinge, cable, or any other manner known in the art. In one embodiment communication interface 191 provides wireless communication as described above between the data logger 120 and external communication interface 192.

Referring to the embodiment depicted in FIG. 8B, the data logger 120 is secured to the base 134 of the storage unit with sensor 172 extending up into the channel 130 of the storage unit 122. Communication between the data logger 120 and external communication interface 192 is achieved through wired or wireless communication as described above.

In one embodiment, the data logger 120 is configured to provide data regarding the conditions of the product 124 once product has been packaged or stored in the storage unit 122. The data logger 120 provides detailed data regarding the product 124 during shipping and storage. In one embodiment, the data logger 120 further provides data regarding whether the product has exceeded predefined parameters or has been stored beyond a predefined time period. Thus, the data logger 120 provides detailed information on the reliability, effectiveness and quality of the product 124 stored within the storage unit 122.

In one embodiment, once the product 124 is placed within the storage unit 122, the data logger 120 is secured to the storage unit 122 as described above. Once secured, the data logger 120 is initialized. Initialization may be performed through external processor 190 communicating control procedures, operational programs or commands and other initialization data to the data logger to be stored in memory 176. Additionally, in one embodiment, external processor downloads to the data logger product information, such as product identification and manufacturing data 230. Predefined limits such as maximum temperature, pressure, humidity and other such limits which are utilized by controller 170 in monitoring the product 124 during shipping and/or storage are also downloaded into memory 176. A time and date stamp are further supplied by the external processor 190 to provide the data logger 120 with valid activation timing and monitoring. In one embodiment, the data logger maintains information representative of when the data logger was initialized to assist the manufacturer and/or distributor in ensuring the data logger was not reinitialized as part of a warranty.

Once the data logger 120 is initialized, the data logger 120 is activated to initiate monitoring of the product 124. Activation of the data logger 120 can be at various times depending on desired monitoring. In one embodiment, the data logger 120 is immediately activated once initialized and secured to the storage unit 122. Immediate activation causes the data logger 120 to immediately start monitoring the product 124. Alternatively, the data logger is activated at some delayed time as previously defined during initialization. For example, at some delayed time as counted by clock 180, or by an external signal received by the data logger 120 activating the monitoring such as just prior to shipment or as the storage unit 122 leaves the product manufacture's or distributor's facility or plant. In one embodiment, the storage unit 122 passes through a magnetic field triggering a magnetic switch within the data logger 120 to activate monitoring. Alternatively, the data logger 120 is activated through wireless communication.

Once activated, the data logger 120 monitors the product 124 based on predefined parameters and procedures. For example, in one embodiment, the data logger 120 monitors the temperature of the product 124 until the product is used by the user or the data logger 120 is deactivated. Monitoring is controlled by control procedures 210. Substantially any convenient scheme can be employed to limit required memory usage and battery power consumption, including monitoring based on continuous or periodic monitoring while data is recorded only if conditions, such as temperature, are outside of predefined limits; data is recorded periodically and stored; or based on a plurality of data sets where a data set is stored only if useful in monitoring a product during shipping, storage and use, such as when the data set is closer or outside of a predefined limit than prior stored data set. Alternatively, a maximum or minimum condition, such as a maximum temperature, is stored once for each predefined period of time, for example each day. In one embodiment, sample data is averaged over time and then recorded.

Data and product information is retrieved at any time after initiation of the data logger 120. In one embodiment, product quality parameters will continue to be monitored and recorded for later verification of product identity and quality by the end-user. Data is capable of being retrieved an unlimited number of times from the data logger 120 to ensure product quality throughout the product life. In one embodiment, product information, manufacturing data and monitored data is automatically transmitted by the data logger 120 to be retrieved by external controller 126, or alternatively, by a display (not shown) in communication with the data logger as part of the cap 136, the storage unit 122 or an external device receiving the transmitted information.

A display device includes substantially any device capable of displaying information such as one or more LCD's, CRT's, LED's, or substantially any other device known in the art which is capable of displaying information from sensors, information stored in memory, information accessible by the controller 170, and/or information produced by the controller 170 which provides an indication of the quality of the product. The display device may be directly coupled with one or more of the data logger, the storage device, and/or the external controller.

In one embodiment, once the product has been shipped to the end-user storage facility, the data and product identity is accessed from the data logger 120 using wired or wireless data transfer devices as described above. This information can be used to determine present product quality and record the product as inventory. The data logger can be configured to store event information such as when the product was received, stored, checked, dispensed, or other useful information. Once in the end-user storage facility, the data logger 120 can continuously monitor and record the critical parameters of the product. Periodic scanning of the data logger memory 176 (see FIG. 1) is used to check product quality and inventory. Additionally, the data logger 120 may be used for Last-In-Last-Out (LIFO) or First-In-First-Out (FIFO) inventory management of time sensitive inventory.

In one embodiment, the data logger 120 provides notification to the end-user when the product 124 has exceeded a parameter or has exceeded a shelf life. For example, the data logger 120 includes a display or LED mounted external to the storage unit 122 in a location for easy viewing which is activated or illuminated by the data logger 120 when the product 124 has exceeded any pre-set parameters, such as shelf life or maximum temperature. The display, in one embodiment, is couple with communication interface 174 to receive data, and in one embodiment, the display is coupled with the controller 170. Alternatively, the data logger 120 generates an audible sound to signal a pre-set parameter has been exceeded. The data logger 120 may utilize remote communication capabilities of the communication interface 174 to communicate if pre-set parameters have been exceeded.

In one embodiment, at the point of use by end-user, the data logger 120 verifies that predefined critical product specifications have been met or not exceeded throughout the period from activation of the data logger 120 up to and including the time of use.

FIG. 9 depicts a simplified block diagram of the storage unit 122 loaded into an end-use equipment 290 such as a chemical delivery system as is known in the art. In one embodiment, end-use equipment 290 is an external control system 189 (see FIG. 5) as described above. In one embodiment, end-use equipment 290 includes a communication interface 292 similar to external communication interface 190 which provides wired or wireless communication between the data logger 120 and end-use equipment 290. In one embodiment, end-use equipment 290 includes a controller 294 which provides control for the end-use equipment and retrieves data 226, such as product information 230 and monitored data 244, from the data logger memory 176 (see FIG. 1). Controller 294 is implemented through substantially any manner of controller known in the art including an external computer, internal CPU, internal microprocessor, internal multiprocessor and substantially any other device or combination of devices known in the art to provide control. In one embodiment, controller 294 is configured to be substantially similar to external control system 126 (see FIG. 1) as described above to obtain the data 226 stored within the data logger 120 as well as present monitoring data. End-use equipment 290 retrieves data 226 from the data logger 120 based on requests from end-use equipment 290. Retrieved shipping, storage and present use data 226 is compared by end-use equipment 290 to data available to the end-use equipment through a memory or database (not shown) or other means. End-use equipment controller 294 verifies the product 124 based in part on logging data and determines the quality of the product 124 based on the comparisons. If the product 124 is not the expected product, or the product 124 fails to meet predefined parameters and limits, the end-use equipment 290 will lock-out the product 124 and prevent the use of the product 124. The end-use equipment will further signal an alarm or error to notify user that the product 124 is locked-out. In one embodiment, the end-use equipment 290 includes one or more displays 295 for displaying information relating to the product and the quality of the product.

Various levels of security may be employed within the data logger 120 to ensure the end-user does not inadvertently, or purposefully, use a product that is determined to be incorrect or outside quality specifications. Once a product identification and quality specifications have been verified, end-use equipment 290 begins use of the product 124. During product transfer and use, product parameters and conditions are continually monitored through data logger 120. In one embodiment, product level detection is monitored in real-time using a level sensor configured to determine the remaining amount of the product 124. For example, level sensor is a pressure sensor which allows the data logger processor 170 to determine when the product 124 has been exhausted, and to communicate the level to end-use equipment 290. When the storage unit 122 is empty, the data logger 120 signals end-use equipment controller to halt the extraction of the product 124 from the storage unit 122.

In one embodiment, the storage unit 122 and the data logger 120 are reusable. Once the product 124 has been emptied from the storage unit 122, the storage unit 122 is returned to the original product manufacturer or distributor. In one embodiment, end-user controller 294 signals the data logger 120 to shut down or shift to a power conservation mode of operation prior to shipping the storage unit 122 back to the manufacturer or distributor once the data logger 120 signals end-user controller that the storage unit 122 is empty. In one embodiment, once the data logger determines the storage unit 122 is empty, the data logger 120 shuts itself off or transitions to a power conservation mode where the data logger halts monitoring. The product manufacturer or distributor receives the returned empty storage unit 122 then cleans the storage unit 122 and makes the storage unit 122 ready for reuse.

Prior to re-using the data logger 120, the data logger memory 176 is erased and reinitialized as described above when the storage unit 122 is loaded with a new product 124. In one embodiment, the data logger 120 is capable of being used with a wide variety of products once the data logger 120 is accurately initialized and provided with control procedures. In one embodiment, the storage unit 122 is configured to provide storage for one of a plurality of different products 124. Both the data logger 120 and the storage unit 122 are capable of a plurality of reuses.

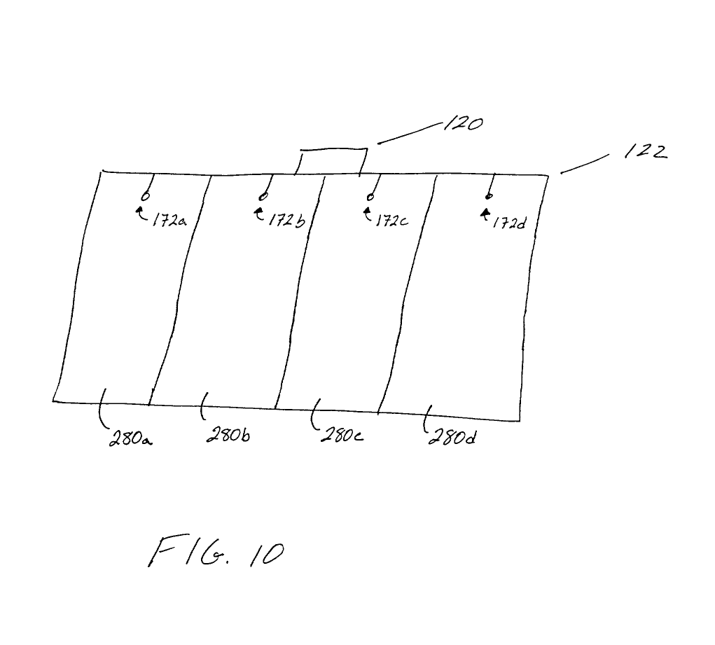

FIG. 10 depicts a simplified block diagram of one implementation of one embodiment where the data logger 120 includes a plurality of sensors 172a-d, each positioned proximate one of a plurality of storage units or sub-storage units 280a-d. In one embodiment, the storage unit 122 includes a plurality of sub-storage units 280a-d where the data logger 120 is secured to the storage unit 122 with the plurality of sensors 172a-d coupled with one or more of the sub-storage units 280a-d providing monitoring data 244 to the data logger 120 for the sub-storage units 280. Monitored data 244 is communicated from sensors 172 to the data logger 120 through wired or wireless communication.

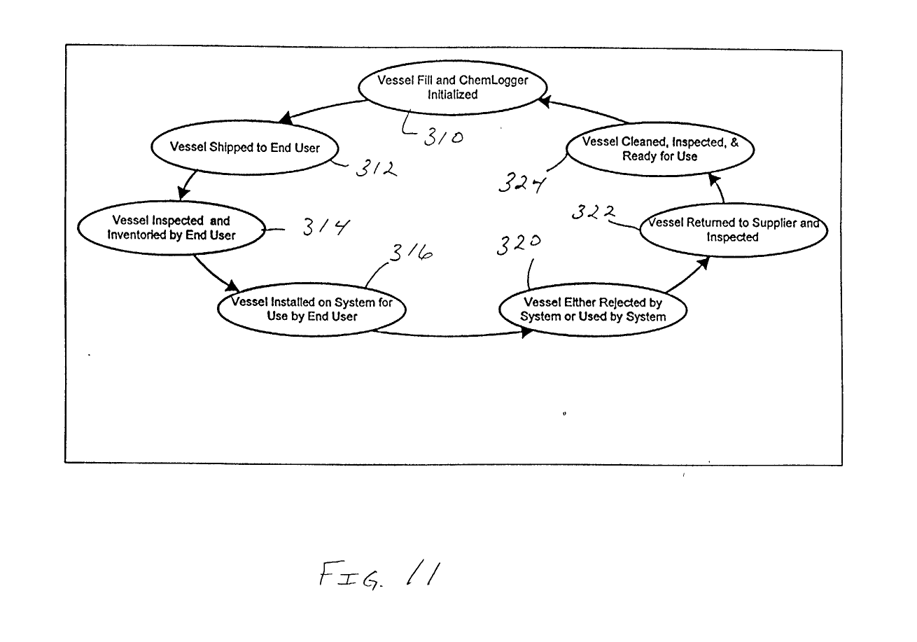

FIG. 11 depicts a flow diagram of one embodiment of the use of the data logger 120 and secured with a storage unit 122. Initially, in step 310 the storage unit 122 is filled with the product 124 and the data logger 120 is initialized as described above. In step 312, the product 124, stored in the storage unit 122, is shipped to an end-user. In step 314, the storage unit 122 is inventoried by the end-user. The storage unit is inventoried through communication between the data logger and an external controller or computer, and monitored data 244 (see FIG. 2) is retrieved from the data logger 120 without user interaction. In step 316, the storage unit is installed into end-use equipment 290 (see FIG. 9). In step 320, end-use equipment 290 verifies the product 124 stored within the storage unit 122 and further verifies the quality of the product by accessing the monitored data stored within the memory 176 of the data logger 120. In step 320, in one embodiment, the end-use equipment 290 will prevent the use of the product 124 within the storage unit 122 if predefined parameters have been exceeded.

In one embodiment, once the storage unit 122 is emptied, or alternatively, the end-use equipment 290 prevents the use of the product 124, the data logger 120 and the storage unit 122 are returned to the product manufacturer or distributor in step 322. In step 324, the storage unit 122 is cleaned and inspected for reuse. The data logger memory 176 is cleared for reuse in step 324. The data logger memory 176 is cleared in step 310 just prior to initialization.

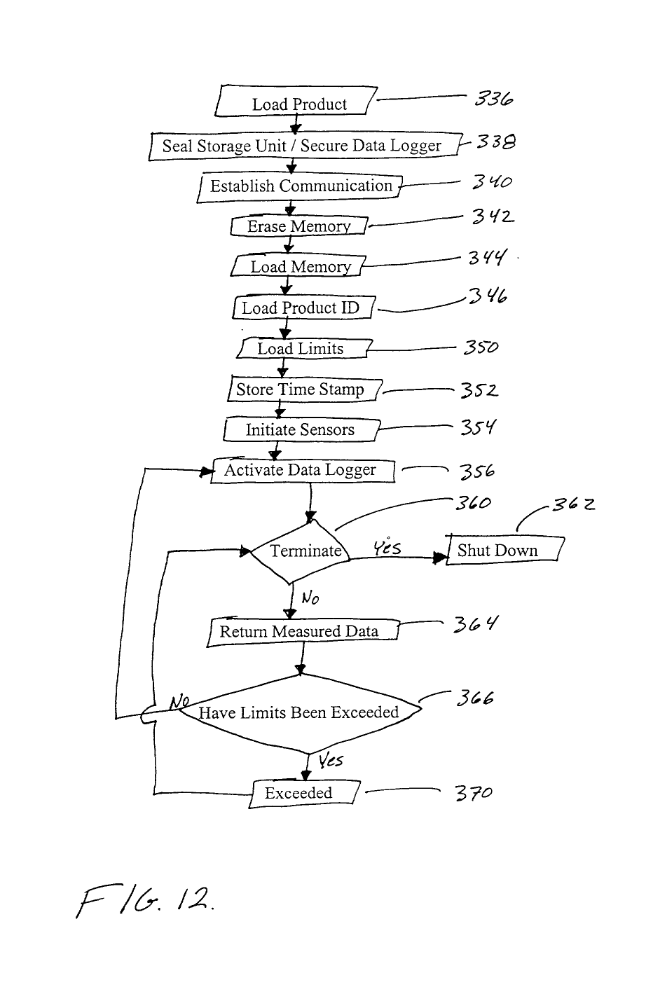

FIG. 12 shows a flow diagram for one implementation of the initialization and activation of the data logger 120. In step 336, the product 124 is initially loaded or packaged into the storage unit 122. The storage unit 122 is sealed and the data logger 120 is secured to the storage unit in step 338. In step 340, the external controller 126 establishes communication with the data logger 120 through the communication interface 174. Communication can be wired or wireless as described above. In step 342, the data logger memory 176 is erased and reinitialized. In one embodiment, step 342 is performed if the data logger has been previously used to monitor an earlier shipped product. In step 344, external controller 126 loads control procedures 220 and programs 224 into memory 176. In step 346, product identification and manufacturing data is loaded into the memory 176. In step 350, predefined limits and parameters of the product 124 are loaded into the memory 176 for reference by the data logger controller 170 during monitoring of the product 124. In step 352, a time stamp and date stamp are stored and initialized in the memory 176 and the clock 180 is activated. In step 354, one or more sensors 172 are initiated. The data logger 120 is then activated in step 356 and the data logger 120 begins monitoring the product 124 through the sensors 172. Condition 360 determines if the data logger 120 has been instructed by the external controller 126, end-use equipment 290 (see FIG. 9) or the data logger 120 itself to terminate monitoring of the product 124. If the data logger 120 has been instructed to terminate monitoring, step 362 is entered where sensor monitoring and data storage is shut down and in one embodiment the data logger 120 is shut down or shifted to a power conservation mode. In one embodiment, the data logger records the time and status when shutdown is initiated or requested. If the data logger 120 has not been instructed to terminate monitoring, step 364 is entered where the sensors 172 are active and return results of measured data are received from sensors. In one embodiment, the controller 170 activates the sensors 172 and obtains the results of measured data. The controller 170 receives monitored data 244 from predefined sensors 172 and determines if results and/or data are to be stored, and stores the results and data in the memory 176. In condition 366, the controller 170 compares the monitored data 244 with product limits and parameters 234 to determine if any limits have been exceeded. If limits have not been exceeded, the process returns to step 356 to continue to receive monitored data 244. If limits have been exceeded the process shifts to step 370 and signals that product limits have been exceeded as described above, and the process returns to step 360 to signal the termination of monitoring. If limits have not been exceeded in condition 366, the process returns to step 356 to continue monitoring.

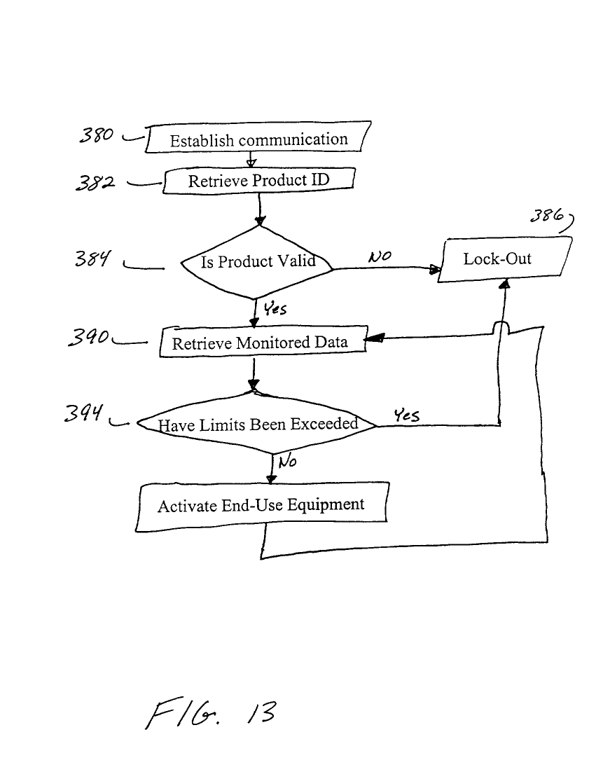

FIG. 13 shows a flow diagram of one implementation of one embodiment of a process of end-use equipment 290 interacting with the data logger 120 and the storage unit 122 to withdraw the product 124 from the storage unit 122. In step 380, the end-use equipment 290 establishes communication with the data logger 120 through wired or wireless communication as described above. In step 382, the end-use equipment 290 retrieves product identification and manufacturing data 230. In condition 384, the end-use equipment 290 determines if the product 124 stored within the storage unit 122 is the expected product. If not, step 386 is entered where the storage unit is locked-out such that the product 124 cannot be withdrawn from the storage unit 122 and the end-use equipment 290 signals an error or alarm. If product 124 is the expected product, step 390 is entered where end-use equipment 290 retrieves stored and continuous monitor data 244. In step 394, an external controller 294 of end-use equipment 290 compares monitored data 244 with internal parameters and limits. In condition 394, it is determined whether the monitored data 244 exceeds internal limits. If yes, step 386 is entered locking-out the storage unit 122. If limits are not exceeded, the end-use equipment 290 is activated to deliver the product 124 as needed in step 396. The process returns to step 390 to continue to retrieve continuous monitored data 244.

As taught by the foregoing description and examples, an apparatus and method for packaging, shipping, monitoring and/or verifying a product has been provided by the present invention. The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents. The invention now being fully described, it will be apparent to one of ordinary skill in the art that many changes and modifications can be made thereto without departing from the spirit or scope of the appended claims.

What is claimed is:

1. An apparatus for monitoring a product placed in a storage unit, the apparatus comprising:
at least one sensor positioned in close proximity to the product and configured to measure at least one condition of the product;
at least one controller coupled with the at least one sensor;
memory coupled with the at least one controller;
wherein the at least one controller is configured to receive information from the at least one sensor and to store at least a portion of the information in the memory; and
a communication interface coupled with the at least one controller, and configured to communicate at least a portion of the information stored in the memory.

2. The apparatus as claimed in claim 1, wherein:
the memory is further configured to store manufacturing data; and
the communication interface is further configured to communicate the manufacturing data.

3. The apparatus as claimed in claim 1, wherein:
the communication interface is configured to communicate by wireless communication.

4. The apparatus as claimed in claim 1, wherein:
the at least one controller utilizes control procedures to control the at least one sensor to control when information received from the at least one sensor is stored in the memory.

5. The apparatus as claimed in claim 1, further comprising:
a housing, wherein the at least one controller, the memory and the communication interface are positioned within the housing.

6. The apparatus as claimed in claim 5, wherein the housing is secured to the storage unit such that at least a portion of the housing extends into the storage unit.

7. The apparatus as claimed in claim 5, wherein the housing is removably secured to the storage unit.

8. The apparatus as claimed in claim 1, wherein:
the at least one controller is configured to determine at least one quality of the product and the communication interface is configured to communicate the at least one quality of the product.

9. The apparatus as claimed in claim 8, further comprising:
an external control system coupled with the communication interface, and the external control system is configured to receive the at least one quality of the product.

10. The apparatus as claimed in claim 1, further comprising:
an external control system coupled with the communication interface, wherein the communication interface is configured to at least receive information from the external control system.

11. The apparatus as claimed in claim 10, further comprising:
the communication interface is configured to at least receive control procedures from the external control system, wherein the at least one controller utilizes the control procedures in providing control to the at least one sensor.

12. The apparatus as claimed in claim 10, wherein:
the external control system wirelessly couples with the communication interface such that the communication interface wirelessly communicates with the external control system.

13. The apparatus as claimed in claim 1, wherein:
the communication interface is configured to communicate the at least one condition of the product.

14. The apparatus as claimed in claim 13, further comprising:
an external controller being coupled with the communication interface, and configured to communicate with the communication interface;
the external controller is configured to determine a quality of the product; and
the external controller includes a display device capable of displaying the quality of the product.

15. An apparatus for monitoring a product, comprising:
at least a first sensor positioned proximate a first product, and configured to measure at least a first condition of the first product;
a controller coupled with the first sensor, and configured to control the first sensor; and
a communication interface coupled with the controller, and configured communicate the first condition.

16. The apparatus as claimed in claim 15, further comprising:
a display coupled with the communication interface and configured to receive the first condition and display the first condition.

17. The apparatus as claimed in claim 15, further comprising:
an external controller coupled with the communication interface, and configured to receive at least the first condition and determine a quality of the first product.

18. The apparatus as claimed in claim 17, wherein:
the external controller is configured to supply control procedures to the controller, such that the controller utilizes the control procedures to at least in part control the first sensor.

19. The apparatus as claimed in claim 15, further comprising:
a first storage unit configured to store the first product, wherein at least the controller is secured to the first storage unit.

20. The apparatus as claimed in claim 19, further comprising:
the first storage unit having a channel extending into the storage unit, wherein the at first sensor is positioned within the channel.

21. The apparatus as claimed in claim 19, further comprising:
at least a second sensor coupled with the controller;
a second storage unit configured to store a second product, wherein the second sensor is position proximate the second product, and the second sensor is configured to monitor at least one condition of the second product.

22. A method of monitoring a product comprising the steps of:
initiating monitoring;
monitoring at least one condition of one or more sensor in proximity to the product;
retrieving results received in the step of monitoring; and
storing the results of the monitoring of the at least one condition; and
accessing the stored results.

23. The method as claimed in claim 22, further comprising the step of:
determining a quality of the product based on the results.

24. The method as claimed in claim 22, further comprising the step of:
loading the product into a storage unit for storage prior to the step of monitoring the at least one condition.

25. The method as claimed in claim 22, wherein the step of monitoring includes periodically monitoring the at least one condition.

26. The method as claimed in claim 22, wherein the step of monitoring includes monitoring the at least one condition based on information received from the sensors.

27. The method as claimed in claim 26, wherein the step of monitoring includes controlling the monitoring through control procedures.

28. A method of monitoring a product during at least one of shipment, storage and use, the method comprising the steps of:
initiating monitoring;
monitoring at least one condition of the product;
storing results of monitoring the at least one condition;
determining a quality of the product based on the stored results; and
accessing the determined quality of the product.

29. The method as claimed in claim 28, further comprising the step of:
displaying the stored results.

30. The method as claimed in claim 28, further comprising the step of:
communicating the results to an external device.

31. The method as claimed in claim 30, wherein the step of communicating including wirelessly communicating the results.

32. The method as claimed in claim 28, further comprising the steps of:
storing a product identification;
the step of accessing including accessing the product identification; and
verifying the product based on the product identification.

33. The method as claimed in claim 28, further comprising the steps of:
accessing the stored results;
communicating the results to an external device; and
the step of determining the quality including determining the quality through the external device.

34. A method of monitoring a quality of a product during at least one of shipping, storing and using, the method comprising the steps of:
positioning a sensor proximate a first product;
activating the sensor to monitor at least one condition of the first product;
monitoring the sensor;
recording results obtained from the sensor; and
determining a quality of the first product.

35. The method as claimed in claim 34, wherein:
the step of determining the quality of the first product includes signaling if a threshold of the at least one condition has been exceeded.

36. The method as claimed in claim 35, further comprising the step of:
preventing the use of the first product if the threshold of the at least on condition has been exceeded.

37. The method as claimed in claim 34, further comprising:
communicating the results obtained from the sensor to an external controller; and
performing the step of determining the quality of the first product by the external controller.

38. The method as claimed in claim 34, further comprising:
clearing the recorded results;
positioning the sensor proximate a second product;
activating the sensor to monitor at least one condition of the second product;
monitoring the sensor;
recording results obtained from the sensor; and
determining a quality of the second product.
